(19) United States
(12) Patent Application Publication
(10) Pub. No.: US 2019/0255615 A1
(43) Pub. Date: Aug. 22, 2019

(54) METHOD AND DEVICE FOR SPRAYING A LIQUID RAW MATERIAL FOR THREE-DIMENSIONAL PRINTING

(71) Applicant: NANJING TAITAO INTELLIGENT SYSTEM CO., LTD., Jiangsu (CN)

(72) Inventor: Fupeng Liang, Jiangsu (CN)

(21) Appl. No.: 16/333,477

(22) PCT Filed: Sep. 18, 2017
(86) PCT No.: PCT/CN2017/102041

§ 371 Date: Mar. 14, 2019

(30) Foreign Application Priority Data
Sep. 19, 2016 (CN) 201610835045.X

(51) Int. Cl. B22F 3/115; B05B 7/22; B22F 3/00

(52) U.S. Cl. CPC B22F 3/115; B33Y 10/00; B22F 3/003; B05B 7/222

(57) ABSTRACT

Disclosed is a method for spraying a liquid raw material for three-dimensional printing, in which a liquid raw material inside a flow channel is sprayed out of the flow channel, a liquid section or a droplet is formed outside the flow channel, the spraying process is controlled by a control circuit, and inside the flow channel, the liquid raw material is fully or partially connected to a gasification circuit, the liquid raw material which is connected to the gasification circuit has a region with a relatively high resistance (14), a current of a certain intensity is applied to the liquid raw material which is connected to the gasification circuit, the region with a relatively high resistance of the liquid raw material is fully or partially gasified, and an impact force generated through gasification is utilized to push the liquid raw material out of the flow channel, and thus the spraying of the liquid raw material is achieved. Disclosed is a device for spraying a liquid raw material for three-dimensional printing, which mainly consists of a housing and a control circuit, wherein a raw material inlet and a raw material outlet are arranged on the housing, a flow channel is arranged inside the housing, the control circuit controls an operating process, a narrow region is arranged inside the flow channel, an electrical access region is formed on each side of the narrow region. The method and the device can realize a high-speed spraying of a liquid raw material in the field of 3D printing, a flexible control over the fluidity of the liquid raw material is obtained, raw material droplets with a tiny volume can be generated, and the structure is simple, the stability is high.

### FIELD OF THE INVENTION

The present invention relates to the technology of spraying a liquid raw material in the technique of three-dimensional printing, in particular to a method and device for spraying a liquid raw material for three-dimensional printing, belonging to the technical field of additive manufacturing.

### BACKGROUND OF THE INVENTION

Three-dimensional printing technology originated in the U.S. at the end of the 19^{th} century, and was perfected and commercialized in Japan and the U.S. in the 1970s and 1980s. The mainstream three-dimensional printing technologies commonly seen now, such as Stereo Lithography Apparatus (SLA), Fused Deposition Modeling (FDM), Selecting Laser Sintering (SLS) and Three Dimensional Printing and Gluing (3DP), were commercialized in the U.S. in the 1980s and the 1990s. In the technology in which three-dimensional printing is achieved through stacking a molten raw material, such as the commonly seen FDM plastic printing and other metal printing with similar principles, one of the important core components is a furnace/extrusion head/generation apparatus which generates a molten raw material. For another example, a printing technology for spraying a molten raw material also belongs to stacking a molten raw material, and its spraying device for a molten raw material is also a core component. At present, many patent applications on a generation apparatus for generating a molten metal raw material are available, such as a Chinese patent application with an application number of 201410513433.7 and entitled “3D Printing Head for Metal Melt Extrusion Building”, and a Chinese patent application with an application number of 201520533246.5 and entitled “Apparatus for Semi-solid Metal Extrusion Deposition Building”. Through these patent applications, droplets cannot be generated and continuous metal flows can be generated. An air pressure can also be adopted as a spraying power to generate metal droplets, such as an apparatus and method recorded in the literature entitled “Experiments on remelting and solidification of molten metal droplets deposited in vertical columns” (source: title of the journal: Journal of Manufacturing Science and Engineering-Transactions of the Asme, Pages 311-318, No. 2, Vol. 129, 2007). Its major principle is as follows: a pulsed air current is adopted to generate a pulsed pressure vibration inside a miniature furnace/crucible to form metal droplets at an outlet of a nozzle. A Chinese patent application with an application number of 201520561484.7 and entitled “Liquid Metal Printing Cartridge” uses a similar method as the technique recorded in the literature; for another example, in a Chinese patent application with an application number of 201520644682.X and entitled “Apparatus for Metal 3D Printing with Supporting Structure”, a pulsed air current/air pressure is also adopted to generate metal droplets. In these methods for generating metal droplets, metal droplets are generated by applying a pulsed pressure and utilizing the characteristics of a fluid, and continuous metal flows can also be generated; however, in these technologies, solid raw materials cannot be added continuously in an operating process, which brings inconvenience to some printing situations (for example, when printing a large-scale metal component), meanwhile, in this type of technology, since a gas is in a compressible physical form, pressure conduction is delayed, and the generation speed of metal droplets is low, and even more seriously, the controllability is poor. In the prior art, if a ratio of an inner diameter of a nozzle to an inner diameter of a liquid raw material storage bin or a main flow channel is too small (for example, the inner diameter of a raw material bin or a main flow channel which is connected with a nozzle is 2 mm, and the inner diameter of a nozzle is 50 μm), especially when the raw material is a liquid metal, the surface tension and the viscosity of a liquid raw material are relatively big, then spraying can be achieved only by applying a great pressure to overcome the surface tension and the flow resistance.

In 2D printing technologies, through commonly used spraying techniques, droplets can be generated rapidly, for example, Hewlett Packard of the U.S. and Epson of Japan developed spraying technologies of an ink-jet printer, through which liquid spraying is achieved based on deformation extrusion of a flow channel (an electrodeformation material is arranged on a wall of a flow channel of a nozzle) or partial heating and evaporation (a heating element is arranged on a wall of a flow channel of a nozzle), however, these technologies are not applicable to spraying a molten material with a high melting point (for example, aerial aluminium alloy, copper, stainless steel, etc.), and are not applicable to spraying a liquid material with a high viscosity. Although a multi-jet-fusion (MJF) plastic 3D printing technology disclosed by Hewlett Packard of the U.S. in 2015 used a spraying technique of 2D ink-jet printing, the sprayed liquid is only an auxiliary reagents with a high fluidity (the sprayed reagent is liquid at a normal temperature), and a material of the main part is still solid plastic powder (a plastic powder layer is paved by adopting a method similar to an SLS powder spreading technology).

Some methods of spraying a liquid raw material based on an electric field force, such as an “electric field spraying” technique (please refer to a book Electric Field Spraying, written by Li Jianlin, and published by Shanghai Jiao Tong University Press in 2012), are also available. For another example, Chinese patent applications with an application number of 201610224283.7 (entitled “Liquid Metal Printing Equipment”) and with an application number of 201310618953.X (entitled “3D Printer with Variable Diameter and Driven by High-voltage Static”) also use an electric field driving technique. In these technologies, a high-voltage electrostatic field or a pulsed high-voltage electrostatic field is established between a nozzle (the nozzle must be manufactured from non-conductive materials) and an external electrode (a printing support platform serves as an electrode), so as to achieve spraying of a liquid raw material; however, there are also limitations for “electric field spraying”, for example, since a liquid raw material has viscosity, especially for a liquid metal with a great surface tension, a high-voltage electrostatic field or even an extra-high electrostatic field must be applied to generate a tensile force required for overcoming a viscous force and surface tension of a liquid raw material and generate a certain flow speed. A high-voltage electric field is hazardous, and electric breakdown is prone to occur, and the controllability is not high. Since the controllability of a high-voltage electric field is not high, then a controllability of an electric field spraying process is not high, and the controllability of generated droplets is not high.

### SUMMARY OF THE INVENTION

An objective of the present invention is to provide a method and device for spraying, at a high speed, a liquid raw material for three-dimensional printing, and the method and device for spraying has a high spraying controllability, and is especially applicable to application environments in which the liquid raw material to be sprayed is conductive.

Another objective of the present invention is to provide a method and device for spraying, at a high speed with a high controllability, a liquid raw material at a high temperature such as a molten metal for three-dimensional printing.

To achieve the above objective of the present invention, the present invention adopts the following technical solution:

a method for spraying a liquid raw material for three-dimensional printing is provided, in which by means of spraying the liquid raw material, inside a flow channel, out of the flow channel, a liquid section or a droplet is formed outside the flow channel, and the spraying process is controlled by a control circuit, characterized in that:

inside the flow channel, the liquid raw material is fully or partially connected to (linked to or joined into) a gasification circuit; the liquid raw material which is connected to the gasification circuit has a region with a relatively high resistance; a current of a certain intensity is applied to the liquid raw material which is connected to the gasification circuit, the region with a relatively high resistance of the liquid raw material is fully or partially gasified, and an impact force generated through gasification is utilized to push the liquid raw material out of the flow channel, thereby the spraying of the liquid raw material is achieved;

the liquid raw material is conductive; some types of liquid raw materials are conductive at a low voltage, and some types of liquid raw materials are not conductive at a low voltage, but are conductive at a high voltage or at an extra-high voltage, and all of them belong to conductive liquid raw materials;

the gasification circuit is utilized to apply the current to the liquid raw material which is connected with the gasification circuit and thus generate an effect of resistance heating;

as to the region with a relatively high resistance, a resistance of this region with a relatively high resistance is higher than that of other regions of the liquid raw material which is connected to the gasification circuit;

as to the current of a certain intensity applied to the liquid raw material which is connected to the gasification circuit, the intensity of the current at least equals to the intensity required to fully or partially gasify the region with a relatively high resistance of the liquid raw material.

Optionally:

inside the flow channel, the liquid raw material is fully or partially connected to the gasification circuit, and the liquid raw material is connected in series to the gasification circuit;

as to the region with a relatively high resistance, the region with a relatively high resistance is formed through setting a region with a relatively small radial sectional area for the liquid raw material which is connected to the gasification circuit, wherein a general direction in which a gasification current (namely, a current required for gasification) flows in the liquid raw material is an axial direction, and a normal of the radial sectional area is coincided with or in parallel with the axial direction;

the flow channel is a structure which can accommodate the liquid raw material and in which the liquid raw material can flow.

Optionally:

at a starting point when the region with a relatively high resistance is gasified, there exists the liquid raw material between the region with a relatively high resistance and an outlet of the flow channel.

Optionally:

the liquid raw material is a raw material in a molten state, or a raw material in a semi-molten state, or a solution, or a suspension liquid;

the gasification circuit is a part of the control circuit.

Optionally:

major steps of spraying the liquid raw material consist in:

step S1, the control circuit controls the liquid raw material to flow inside the flow channel; and a force which drives the liquid raw material to flow inside the flow channel is one or more of forces including a pressure, a capillary pressure, a gravity, an electric field force, a centrifugal force and an electromagnetic force;

step S2, the liquid raw material forms a region with a relatively high resistance inside the flow channel; the region with a relatively high resistance of the liquid raw material is connected to the gasification circuit;

step S3, the current of a certain intensity is applied, and thus an effect of resistance heating is generated in the region with a relatively high resistance of the liquid raw material, so as to fully or partially gasify the liquid raw material in the region with a relatively high resistance; and the intensity of the current at least equals to the intensity required to fully or partially gasify the region with a relatively high resistance of the liquid raw material;

step S4, an impact force generated through gasification pushes the liquid raw material between the region with a relatively high resistance of the liquid raw material and the outlet of the flow channel out of the flow channel.

Further, the present invention provides a device applied in the above method for spraying a liquid raw material for three-dimensional printing, that is, a device for spraying a liquid raw material for three-dimensional printing, mainly consisting of a housing and a control circuit, wherein a raw material inlet and a raw material outlet are arranged on the housing, a flow channel is arranged inside the housing, the raw material inlet and the raw material outlet are connected with the internal flow channel, and the control circuit controls an operating process; characterized in that:

a narrow region is arranged inside the flow channel, an electrical access region is formed on each side of the narrow region, the electrical access region is utilized to guide a gasification current into the liquid raw material inside the flow channel; the current flows from the electrical access region on one side, through the narrow region, and then into the electrical access region on the other side; when the current flows through the narrow region, the liquid raw material in the narrow region is fully or partially heated and gasified, and an impact force generated through gasification pushes the liquid raw material inside the flow channel to be sprayed (ejected) out of the raw material outlet;

the gasification current is utilized to heat and gasify the liquid raw material;

the electrical access region is actually a region through which the liquid raw material is connected to a gasification current generation circuit in the flow channel.

Optionally:

the number of the flow channel is at least two, there exists an intersection between flow channels, and the narrow region is arranged at the intersection.

Optionally:

the number of the flow channel is one, one end of the flow channel is connected with the raw material inlet, the other end of the flow channel is connected with the raw material outlet, and the narrow region is located between the raw material inlet and the raw material outlet.

Optionally:

a solid raw material transportation unit and a heating unit are provided; the solid raw material transportation unit is utilized to feed the solid raw material into the flow channel; and the heating unit is utilized to heat the solid raw material, so as to generate a liquid raw material and maintain a molten state of the liquid raw material;

or, a heating unit is provided and no solid raw material transportation unit is provided; and the heating unit is utilized to maintain a molten state of the liquid raw material. There are many heating ways for the heating unit, for example, electromagnetic induction heating, resistance heating (resistance heat emission), electric arc heating, plasma heating and laser heating.

Optionally:

an electrode is arranged at the raw material outlet.

Optionally:

a raw material bin or raw material chamber is provided to store the liquid raw material or the solid raw material; and the flow channel is connected with the raw material bin or raw material chamber.

Optionally:

a cooling unit is provided to cool a region which does not need to be heated or which cannot withstand a high temperature.

The present invention has the following beneficial effects:
(1) In the present invention, the liquid raw material inside the flow channel is connected to the control circuit, and a region with a relatively high resistance is formed in the liquid raw material which is connected to the control circuit. A strong current is utilized to gasify the region with a relatively high resistance at a high speed, then a “micro explosion” effect is generated in the flow channel, and a binding or constraining effect of the flow channel on “micro explosion” is utilized to rapidly spray out part of the liquid raw material inside the flow channel, and the process is just like shooting a bullet, thereby an “electronic” spraying is achieved. Therefore, through the present invention, spraying of a liquid raw material at a high speed (especially spraying of a liquid metal) in the field of 3D printing is achieved, and the controllability thereof is extremely high.
(2) A core structure of the device for spraying a liquid raw material according to the present invention is based on a simple flow channel structure and electrode, therefore, it is simple in the structure, the stability thereof is high and the maintainability thereof is strong.
(3) In the device for spraying a liquid raw material according to the present invention, an electric field can be established between the raw material outlet and the liquid raw material inside the flow channel, then an electric field force can be utilized to change the surface tension of the liquid raw material in a narrow region inside the flow channel, or the electric field force can be utilized to pull the flow of the liquid raw material, so as to flexibly control the fluidity (or flowability) of the liquid raw material. Especially when a liquid raw material with a high surface tension and a high viscous force (for example, a molten metal raw material) is used, an electric field force can be used to greatly reduce its surface tension, such that the liquid raw material can easily pass through a small-bore flow channel (such as a flow channel with a diameter of 10 pin) under the driving of a relatively low pressure. Meanwhile, since a distance between the electrode at the outlet of the flow channel and the liquid raw material inside the flow channel is short, the required intensity of the electric field is far lower than that of a high-voltage electric field used in the existing electric field spraying technology, the voltage and the power of the required electric field are both low, and the security and controllability thereof are both higher than those in the prior art. Therefore, through the present invention, the fluidity of the liquid raw material can be controlled flexibly, the liquid raw material with a high surface tension and a high viscous force can be sprayed, and raw material droplets with a tiny volume can be generated.
(4) In the present invention, the liquid raw material is connected to the control circuit and the impact force generated through gasification is utilized to push the spraying of the liquid raw material, and such a principle determines that spraying of a material with a high melting point, such as a molten stainless steel, a molten glass, and a molten ceramics (most types of molten glass and ceramics are also conductive), can be achieved through the present invention. Therefore, the present invention can be used in 3D printing of such materials with a high melting point as a metal and a glass, thereby a technological breakthrough of spraying at a high speed with a high controllability of a material with a high melting point in the field of 3D printing can be achieved.

In summary, the present invention has the following beneficial effects: spraying of a liquid raw material at a high speed in the field of 3D printing is achieved, and the controllability is extremely high. The fluidity of the liquid raw material can be controlled flexibly, thereby spraying of the liquid raw material with a high surface tension and a high viscous force can be achieved, and raw material droplets with a tiny volume can be generated; a technological breakthrough of spraying at a high speed with a high controllability of a material with a high melting point in the field of 3D printing is achieved; and the structure thereof is simple, the stability thereof is high, the security thereof is high and the maintainability thereof is strong. The present invention possesses a substantial progress.

### BRIEF DESCRIPTION OF THE DRAWINGS

FIG. 1 is a schematic diagram illustrating a composition principle of a first specific embodiment of a device for spraying a liquid raw material for three-dimensional printing according to the present invention;

FIG. 2 to FIG. 6 are schematic diagrams illustrating a process of spraying a liquid raw material in a first specific embodiment of a method for spraying a liquid raw material for three-dimensional printing according to the present invention, wherein an arrow P1 in these figures represent an action direction of a pressure;

FIG. 7 is a schematic diagram illustrating a situation that a solid raw material is adopted in the first specific embodiment of a device for spraying a liquid raw material for three-dimensional printing as shown in FIG. 1 and the solid raw material is melted inside a flow channel to obtain a liquid raw material, wherein an arrow D1 in the figure represents an action direction of a driving force;

FIG. 8 is a schematic diagram illustrating a composition principle of a second specific embodiment of a device for spraying a liquid raw material for three-dimensional printing according to the present invention;

FIG. 9 to FIG. 12 are schematic diagrams illustrating a process of spraying a liquid raw material in a second specific embodiment of a method for spraying a liquid raw material for three-dimensional printing according to the present invention;

### REFERENCE NUMERALS IN THE FIGURES

1—housing I, 2—electrode I, 3—electrode II, 4—narrow region I, 5—raw material inlet I, 6—raw material outlet I, 7—control circuit I, 8—liquid raw material I, 9—gasification region I, 10—cutoff liquid raw material I, 11—droplet I, 12—electrical access region I, 13—electrical access region II, 14—region with a relatively high resistance, 15—solid raw material, 16—softened region, 17—liquid raw material II, 18—housing II, 19—electrode III, 20—electrode IV, 21—electrode V, 22—raw material outlet II, 23—raw material inlet II, 24—raw material inlet III, 25—control circuit II, 26—narrow region II, 27—liquid raw material III, 28—liquid raw material IV, 29—gasification region II, 30—cutoff liquid raw material II, 31—droplet II.

### DETAILED DESCRIPTION OF THE EMBODIMENTS

The present invention will be described in detail below with a preferred specific embodiment of the present invention as an example and in combination with accompanying drawings.

In a first specific embodiment of a method for spraying a liquid raw material for three-dimensional printing according to the present invention as shown in FIG. 2 to FIG. 6, a liquid raw material inside a flow channel is sprayed out of the flow channel to form a liquid section or a droplet outside the flow channel, and the spraying process is controlled by a control circuit (namely, a control circuit I 7); the key points lie in that:

inside the flow channel, the liquid raw material (namely, liquid raw material I 8) is fully connected to a gasification circuit (the gasification circuit is a part of the control circuit I 7); the liquid raw material which is connected to the gasification circuit has a region with a relatively high resistance (namely, region with a relatively high resistance 14). A current of a certain intensity is applied to the liquid raw material which is connected to the gasification circuit, so as to fully gasify the region with a relatively high resistance of the liquid raw material, and an impact force generated through gasification is utilized to push part of the liquid raw material out of the flow channel, thereby the spraying of the liquid raw material is achieved (as shown in FIG. 6);

the liquid raw material is conductive; the gasification circuit is utilized to apply the current to the liquid raw material which is connected with the gasification circuit and thus generate an effect of resistance heating; as to the region with a relatively high resistance, a resistance of this region with a relatively high resistance is higher than that of other regions of the liquid raw material which is connected to the gasification circuit; as to the current of a certain intensity applied to the liquid raw material which is connected to a gasification circuit, the intensity of the current at least equals to the intensity required to fully or partially gasify the region with a relatively high resistance of the liquid raw material.

In the present specific embodiment, inside the flow channel, the above liquid raw material is fully connected to the gasification circuit, and the liquid raw material is connected in series to the gasification circuit; as to the region with a relatively high resistance, the region with a relatively high resistance is formed through setting a region with a relatively small radial sectional area for the liquid raw material which is connected to the gasification circuit, wherein a general direction in which a gasification current (namely, a current required for gasification) flows in the liquid raw material is an axial direction, and a normal of the radial sectional area is coincided with or in parallel with the axial direction.

In the present specific embodiment, at a starting point when a region with a relatively high resistance is gasified, there exists the liquid raw material between the region with a relatively high resistance and an outlet of a flow channel.

In the present specific embodiment, the liquid raw material is an aerial aluminum alloy in a molten state.

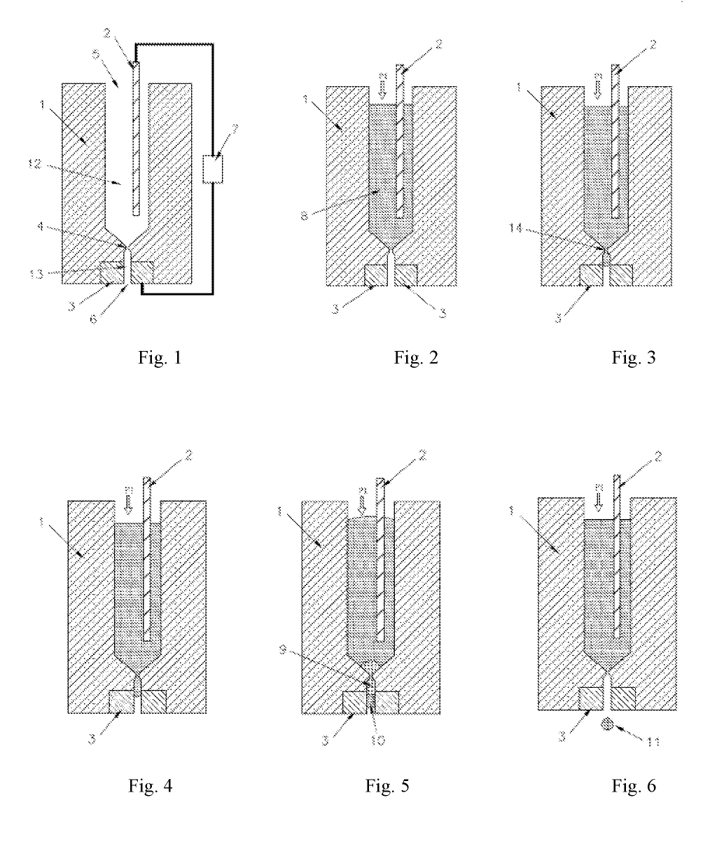

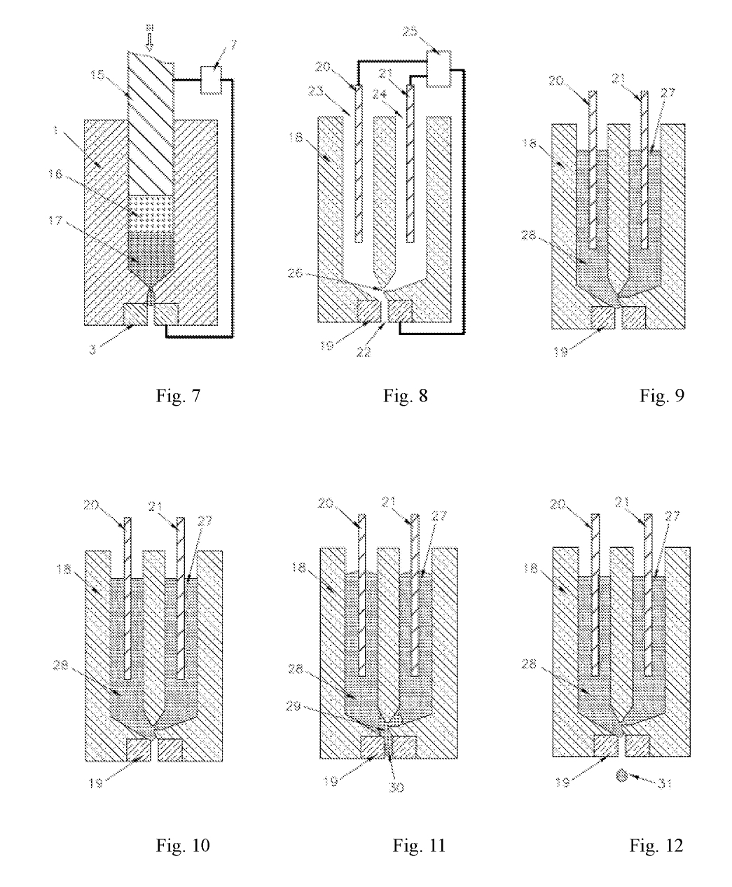

FIG. 1 and FIG. 7 show a first specific embodiment of a device for spraying a liquid raw material for three-dimensional printing according to the present invention. The specific embodiment is a first specific embodiment applying a method for spraying a liquid raw material for three-dimensional printing according to the present invention as shown in FIG. 2 to FIG. 6:

a device for spraying a liquid raw material for three-dimensional printing mainly consists of a housing (namely, housing I 1), a control circuit (namely, control circuit I 7) and a heating unit (not shown in the drawings); wherein a raw material inlet (namely, raw material inlet I 5) and a raw material outlet (namely, raw material outlet I 6) are arranged on the housing I 1, and an electrode (namely, electrode II 3) is arranged at the raw material outlet; a flow channel is arranged inside the housing I 1, the number of the flow channel is one, and the flow channel penetrates through the housing I 1 and the electrode II 3; the raw material inlet I 5 and the raw material outlet I 6 are connected with the internal flow channel; a narrow region (namely, narrow region I 4) is arranged inside the flow channel, one end of the flow channel is connected with the raw material inlet I 5, the other end of the flow channel is connected with the raw material outlet I 6, and the narrow region I 4 is located between the raw material inlet I 5 and the raw material outlet I 6; electrical access regions (namely, electric access region I 12 and electric access region II 13) are arranged on two sides of the narrow region I 4, the electrical access regions are utilized to guide a current into the flow channel, the electrical access regions are regions at which the current is connected to the flow channel, and the electrical access regions are utilized to guide a gasification current into the liquid raw material inside the flow channel; the current flows from the electrical access region on one side, through the narrow region I 4, and then into the electrical access region on the other side; when the current flows through the narrow region I 4, the liquid raw material in the narrow region I 4 is fully or partially heated and gasified. The electrical access region II 13 is connected to the control circuit I 7 through an electrode II 3.

The control circuit I 7 includes a gasification circuit, a logical circuit, a detection circuit, an electric field generation circuit and a drive circuit; the gasification circuit is connected with the logical circuit through a drive circuit, and the gasification circuit is utilized to output a current required for gasifying the liquid raw material in the narrow region I 4 to electrical access regions (namely, electrical access region I 12 and electrical access region II 13) on two sides of the narrow region I 4. The detection circuit is connected with the logical circuit, and the detection circuit is utilized to monitor whether the liquid raw material is in contact with the electrode II 3; the electric field generation circuit is connected with the logical circuit through the drive circuit, and the electric field generation circuit is utilized to establish an electric field between the liquid raw material and the electrode II 3 before the liquid raw material is in contact with the electrode II 3, aiming at reducing the surface tension of the liquid raw material, so as to lower the flow resistance of the liquid raw material in the narrow region I 4 and the electrical access region II 13. When the liquid raw material in the narrow region I 4 needs to be gasified, the logical circuit drives the gasification circuit through the drive circuit to output a strong current within a set time, for example, to output a current with an intensity of 200 A lasting for one five hundred thousandth of a second.

A sectional area of the electrical access region II 13 is greater than or equal to a sectional area of the narrow region I 4, and sections of the electrical access region II 13 and the narrow region I 4 are radial sections of the flow channel. When the sectional area of the electrical access region II 13 is greater than the sectional area of the narrow region I 4, since the sectional area of the narrow region I 4 is relatively small (smaller than the sectional area of the electrical access region I 12 and the electrical access region II 13), a resistance of the liquid raw material in the narrow region I 4 is the largest one, thereby resulting in gasification of the liquid raw material in this region, wherein the gasification degree thereof depends on the intensity and duration of the current applied.

In the present specific embodiment, a diameter of a radial section of the narrow region I 4 is 30 μm, a diameter of the electrical access region I 12 of the flow channel is 800 μm, and a diameter of the electrical access region II 13 of the flow channel is 100 μm.

In the present specific embodiment, the liquid raw material is an aerial aluminum alloy in a molten state, that is, a molten aerial aluminum alloy. The heating unit is mainly composed of (or is) a high temperature resistance wire. The resistance wire is wound outside the housing I 1, and the housing I 1 and the electrode II 3 are heated in a manner of resistance heating (namely, resistance heat emission) to a high temperature of 800° C. The housing I 1 is manufactured from high-purity corundum, and the electrode II 3 is manufactured from special tungsten alloy. The heating unit is controlled by the control circuit I 7.

Since the electrode II 3 is arranged inside the housing I 1, the distance between the electrode II 3 and the narrow region I 4 is short (for example 120 μm), it only needs a low voltage and a low power (for example, the voltage is 100 V and the power is 0.1 W) to establish an electric field between the liquid raw material and the electrode II 3 before the liquid raw material is in contact with the electrode II 3.

The liquid raw material inside the flow channel (for example, the liquid raw material I 8 as shown in FIG. 2) can be obtained from a raw material bin which can store a liquid raw material or generate a liquid raw material, and the liquid raw material can also be generated through heating a solid material inside the flow channel directly. If the liquid raw material is obtained from a raw material bin which can store a liquid raw material or generate a liquid raw material, then the electrical access region I 12 is connected to the control circuit I 7 via the electrode I 2.

If the liquid raw material is generated through heating a solid material inside the flow channel directly, a solid raw material transportation unit (not shown in the drawings) and a heating unit (not shown in the drawings) need to be provided additionally. The solid raw material transportation unit is utilized to feed the solid raw material to the flow channel; and the heating unit heats the solid raw material to generate a liquid raw material and maintain a molten state of the liquid raw material. The electrical access region I 12 is connected to the control circuit I 7 through the solid raw material 15. The solid raw material 15 is composed of an aerial aluminium alloy wire. The solid raw material transportation unit is mainly composed of a wire feeding roller and a motor, wherein the wire feeding roller drives the solid raw material 15 to move in a direction D1 as shown in FIG. 7. As shown in FIG. 7, the solid raw material 15 is heated to generate a liquid raw material II 17 inside the flow channel, a transition region, namely, a softened region 16, is generated between the solid raw material 15 and the liquid raw material II 17. The softened region 16 is deformed under the effect of an extrusion force, the softened region 16 fits closely with a wall of the flow channel to generate an effect of sealing, thereby playing a role of preventing the liquid raw material II 17 from leaking towards the raw material inlet I 5 (under a premise that a feeding speed of the solid raw material is lower than or equal to a spraying amount of the liquid raw material in a unit time).

Specific application solutions:

major steps of spraying a liquid raw material are as listed follows in combination with the first specific embodiment of a method for spraying a liquid raw material for three-dimensional printing according to the present invention and the first specific embodiment of a device for spraying a liquid raw material for three-dimensional printing according to the present invention:

Step S1, as shown in FIG. 2 and FIG. 3, the control circuit controls the liquid raw material I 8 to flow inside the flow channel: as to the liquid raw material (namely, liquid raw material I 8, a molten aerial aluminum alloy) inside the flow channel, under an effect of surface tension effect and a non-invasive (or non-infiltration) influence of the liquid raw material I 8 on an inner surface of the flow channel, at a narrowed position (an intersection between the electrical access region I 12 and the narrow region I 4) of the flow channel, the liquid raw material I 8 cannot flow from the electrical access region I 12 towards the electrical access region II 13 by means of its own gravity, as shown in FIG. 2. The control circuit I 7 startups the electric field generation circuit (a component of the control circuit I 7), an electric field with a voltage of 100 V and a power of 0.1 W is established between the liquid raw material I 8 and the electrode II 3 (an electric arc may be generated between them), meanwhile, a pressure of 1 standard atmospheric pressure is applied to the liquid raw material I 8 (as shown by an arrow P1 in FIG. 2 to FIG. 6), such that the liquid raw material I 8 flows to the electrical access region II 13, as shown in FIG. 3.

Step S2, as shown in FIG. 3 and FIG. 4, the liquid raw material I 8 forms a region with a relatively high resistance inside the flow channel: after the liquid raw material I 8 is in contact with the electrode II 3 (as shown in FIG. 3), the control circuit I 7 shuts off the electric field generation circuit with a duration (or time-lapse) of a set time period (the duration is obtained through a calculation based on such parameters as an intensity of pressure, and a diameter of the flow channel, or obtained through empirical values, for example 20 microseconds), such that a contact area between a front (leading edge) of the liquid raw material I 8 in the electrical access region II 13 and the electrode II 3 exceeds a radial sectional area of the narrow region I 4 (as shown in FIG. 4).

As shown in FIG. 4, the region with a relatively high resistance of the liquid raw material is connected to the gasification circuit: the liquid raw material I 8 bridges (or connects) the electrical access region I 12 and the electrical access region II 13, namely, the liquid raw material I 8 is in sufficient contact with both the electrode I 2 and the electrode II 3.

Step S3, as shown in FIG. 5, a current of a certain intensity is applied to generate an effect of resistance heating in the region with a relatively high resistance of the liquid raw material, so as to fully gasify the liquid raw material in the region with a relatively high resistance: the control circuit I 7 startups the gasification circuit (a component of the control circuit I 7) to apply a current at an intensity of 200 A and with a duration of one five hundred thousandth of a second to the liquid raw material I 8, such that the liquid raw material I 8 in the narrow region I 4 is gasified within one five hundred thousandth of a second, thereby a gasification region I 9 is generated in the flow channel.

Step S4, as shown in FIG. 5 and FIG. 6, an impact force generated through gasification pushes the liquid raw material, which is located between the region with a relatively high resistance of the liquid raw material and the outlet of the flow channel, out of the flow channel: the impact force generated through instant gasification pushes a cutoff liquid raw material I 10, which is located between the narrow region I 4 and the raw material outlet I 6, out of the flow channel within an extremely short time, thereby a droplet I 11 is formed.

As shown in FIG. 9 to FIG. 12, in a second specific embodiment of a method for spraying a liquid raw material for three-dimensional printing according to the present invention, a liquid raw material inside a flow channel is sprayed out of the flow channel, to form a liquid section or a droplet outside the flow channel, and the spraying process is controlled by a control circuit (namely, a control circuit II 25);

inside the flow channels, liquid raw materials (namely, liquid raw material III 27 and liquid raw material IV 28) are partially connected to a gasification circuit (the gasification circuit is a part of the control circuit); the liquid raw materials which are connected to the gasification circuit have a region with a relatively high resistance (namely, a narrow region at an intersection between the liquid raw material III 27 and the liquid raw material IV 28). A current of a certain intensity is applied to the liquid raw materials which are connected to the gasification circuit, so as to fully gasify the region with a relatively high resistance of the liquid raw materials, an impact force generated through gasification is utilized to push part of the liquid raw materials out of the flow channels, thereby the spraying of the liquid raw materials is achieved (as shown in FIG. 12);

the liquid raw materials are conductive; the gasification circuit is utilized to apply the current to the liquid raw materials which are connected with the gasification circuit and thus generate an effect of resistance heating; as to the region with a relatively high resistance, a resistance of this region with a relatively high resistance is higher than that of other regions of the liquid raw materials which are connected to the gasification circuit; as to the current of a certain intensity applied to the liquid raw materials which are connected to a gasification circuit, the intensity of the current at least equals to the intensity required to fully or partially gasify the region with a relatively high resistance of the liquid raw materials.

In the present specific embodiment, inside the flow channels, the above liquid raw materials are partially connected to the gasification circuit, and the liquid raw materials are connected in series to the gasification circuit; as to the region with a relatively high resistance, the region with a relatively high resistance is formed through setting a region with a relatively small radial sectional area for the liquid raw materials which are connected to the gasification circuit, wherein a general direction in which a gasification current (namely, a current required for gasification) flows in the liquid raw materials is an axial direction, and a normal of the radial sectional area is coincided with or in parallel with the axial direction.

In the present specific embodiment, at a starting point when the region with a relatively high resistance is gasified, there exist the liquid raw materials between the region with a relatively high resistance and an outlet of the flow channel.

In the present specific embodiment, the liquid raw materials are composed of an aerial aluminum alloy in a molten state.

FIG. 8 shows a second specific embodiment of a device for spraying a liquid raw material for three-dimensional printing according to the present invention. The specific embodiment is a second specific embodiment applying a method for spraying a liquid raw material for three-dimensional printing according to the present invention as shown in FIG. 9 to FIG. 12: a device for spraying a liquid raw material for three-dimensional printing mainly consists of a housing (namely, housing II 18), a control circuit (namely, control circuit II 25) and a heating unit (not shown in the drawings); wherein two raw material inlets (namely, raw material inlet II 23 and raw material inlet III 24) and one raw material outlet (namely, raw material outlet II 22) are arranged inside the housing II 18, an electrode (namely, electrode III 19) is arranged at the raw material outlet; a flow channel is arranged inside the housing II 18, and the number of the flow channel is two; wherein the first flow channel is a main flow channel, which penetrates through the housing II 18 and the electrode III 19, and is connected with the raw material inlet II 23 and the raw material outlet II 22; the second flow channel is a secondary flow channel, wherein one end of the secondary flow channel is connected with the raw material inlet III 24, the other end is intersected with the main flow channel, and a narrow region (namely, narrow region II 26) is arranged at an intersection between the flow channels. The main flow channel and the secondary flow channel on two sides of the narrow region II 26 are both electrical access regions, and the electrical access regions are utilized to guide a gasification current into the liquid raw materials inside the flow channels; the electrical access regions are connected to the gasification circuit (a submodule of the control circuit II 25) via an electrode IV 20 and an electrode V 21; and the electrode III 19 is connected to the control circuit II 25.

The composition of the control circuit II 25 is the same as that of the control circuit I 7, and the control circuit II 25 comprises a gasification circuit, a logical circuit, a detection circuit, an electric field generation circuit and a drive circuit; the gasification circuit is connected with the logical circuit through a drive circuit, and the gasification circuit is utilized to output a current required for gasifying the liquid raw materials in the narrow region II 26 into electrical access regions (namely, the main flow channel and the secondary flow channel) on two sides of the narrow region II 26. The detection circuit is connected with the logical circuit, and the detection circuit is utilized to monitor whether the liquid raw materials are in contact with the electrode III 19; the electric field generation circuit is connected with the logical circuit through the drive circuit, and the electric field generation circuit is utilized to establish an electric field between the liquid raw material in the main flow channel and the liquid raw material in the secondary flow channel before the liquid raw material in the main flow channel is in contact with the liquid raw material in the secondary flow channel, aiming at reducing the surface tension of the liquid raw materials and pulling the two to move towards each other. When the liquid raw materials in the narrow region II 26 need to be gasified, the logical circuit drives the gasification circuit through the drive circuit to output a strong current within a set time, for example, to output a current with an intensity of 200 A lasting for one five hundred thousandth of a second.

In the present specific embodiment, the liquid raw materials are composed of an aerial aluminum alloy in a molten state, that is, molten aerial aluminum alloy. The heating unit is mainly composed of a high temperature resistance wire. The resistance wire is wound outside the housing II 18, and the housing II 18 and the electrode III 19 are heated in a manner of resistance heating (namely, resistance heat emission) to a high temperature of 800° C. The housing II 18 is manufactured from high-purity corundum, and the electrode III 19 is manufactured from special tungsten alloy. The heating unit is controlled by the control circuit II 25.

Specific application solutions:

major steps of spraying a liquid raw material are listed as follows in combination with the second specific embodiment of a method for spraying a liquid raw material for three-dimensional printing according to the present invention and the second specific embodiment of a device for spraying a liquid raw material for three-dimensional printing according to the present invention:

Step S101, as shown in FIG. 9 and FIG. 10, the control circuit II 25 controls the liquid raw material III 27 and the liquid raw material IV 28 to flow inside the flow channels: as to liquid raw materials (namely, liquid raw material III 27 and liquid raw material IV 28, molten aerial aluminum alloy) inside the flow channels, under an effect of surface tension and a non-invasive influence of liquid raw materials on an inner surface of the flow channels, in a narrow region at an intersection between the main flow channel and the secondary flow channel, the liquid raw material III 27 and the liquid raw material IV 28 cannot flow through the narrow region (namely, narrow region II 26) at the intersection position by means of its own gravity, thus the liquid raw material III 27 and the liquid raw material IV 28 cannot contact with each other, and under an effect of gravity, a front of a lower end of the liquid raw material IV 28 in the main flow channel is in contact with the electrode III 19, but cannot pass through the raw material outlet II 22, as shown in FIG. 9. The control circuit II 25 determines the position of the front of a lower end of the liquid raw material IV 28 based on the fact that whether the front of a lower end of the liquid raw material IV 28 is in contact with the electrode III 19 or not. The control circuit II 25 startups an electric field generation circuit (a component of a control circuit II 25), an electric field with a voltage of 500 V and a power of 0.1 W is established between the liquid raw material III 27 and the liquid raw material IV 28 (an electric arc may be generated between them), meanwhile, a surface tension of the liquid raw material III 27 and the liquid raw material IV 28 at the narrow region II 26 is changed by means of an electric field force, and the liquid raw material III 27 and the liquid raw material IV 28 are pulled to be close to and in contact with each other by means of the electric field force.

Step S102, as shown in FIG. 10, the liquid raw material III 27 and the liquid raw material IV 28 form a region with a relatively high resistance in the flow channels: after the liquid raw material III 27 is in contact with the liquid raw material IV 28 (as shown in FIG. 10), the control circuit II 25 shuts off the electric field generation circuit, and the liquid raw material III 27 and the liquid raw material IV 28 form a region with a relatively high resistance (with regard to liquid raw materials in the entire flow channels) at a connecting position in the narrow region II 26. Each side of the region with a relatively high resistance of the liquid raw materials is connected to the gasification circuit (a submodule of the control circuit II 25) through the electrode IV 20 and the electrode V 21.

Step S103, as shown in FIG. 11, a current of a certain intensity is applied to generate an effect of resistance heating in the region with a relatively high resistance of the liquid raw materials, so as to fully gasify the liquid raw materials in the region with a relatively high resistance: the control circuit II 25 startups the gasification circuit (a component of the control circuit II 25) to apply a current at an intensity of 200 A and with a duration of one five hundred thousandth of a second to the liquid raw material in the narrow region II 26, such that the liquid raw materials in the narrow region II 26 are gasified within one five hundred thousandth of a second, thereby a gasification region II 29 is generated inside the flow channels.

Step S104, as shown in FIG. 11 and FIG. 12, the impact force generated through gasification pushes the liquid raw materials, which are located between the region with a relatively high resistance of the liquid raw materials and the outlet of the flow channel, out of the flow channels: the impact force generated through instant gasification pushes a cutoff liquid raw material II 30, which is located between the narrow region II 26 and the raw material outlet II 22, out of the flow channels within an extremely short time, thereby a droplet II 31 is formed.

What is described above are merely some preferred specific embodiments of the present invention, and should not be deemed to restrict the implementation scope of the present invention, that is, equivalent transformations and modifications made based on the contents of claims and description of the present invention shall all fall within the scope of the present invention.

1. A method for spraying a liquid raw material for three-dimensional printing, in which by means of spraying a liquid raw material inside a flow channel out of the flow channel, a liquid section or a droplet is formed outside the flow channel, and the spraying process is controlled by a control circuit, wherein:
inside the flow channel, the liquid raw material is fully or partially connected to a gasification circuit; the liquid raw material which is connected to the gasification circuit has a region with a relatively high resistance; a current of a certain intensity is applied to the liquid raw material which is connected to the gasification circuit, the region with a relatively high resistance of the liquid raw material is fully or partially gasified, and an impact force generated through gasification is utilized to push the liquid raw material out of the flow channel, thereby the spraying of the liquid raw material is achieved;
the liquid raw material is conductive;
the gasification circuit is utilized to apply the current to the liquid raw material which is connected with the gasification circuit and thus generate an effect of resistance heating;
as to the region with a relatively high resistance, a resistance of this region is higher than that of other regions of the liquid raw material which is connected to the gasification circuit;
as to the current of a certain intensity applied to the liquid raw material which is connected to a gasification circuit, the intensity of the current at least equals to the intensity required to fully or partially gasify the region with a relatively high resistance of the liquid raw material.

2. The method for spraying a liquid raw material for three-dimensional printing of claim 1, wherein:
inside the flow channel, the liquid raw material is fully or partially connected to the gasification circuit, and the liquid raw material is connected in series to the gasification circuit;
as to the region with a relatively high resistance, the region with a relatively high resistance is formed through setting a region with a relatively small radial sectional area for the liquid raw material which is connected to the gasification circuit, wherein a general direction in which a gasification current flows in the liquid raw material is an axial direction, and a normal of the radial sectional area is coincided with or in parallel with the axial direction;
the flow channel is a structure which can accommodate the liquid raw material and in which the liquid raw material can flow.

3. The method for spraying a liquid raw material for three-dimensional printing of claim 1, wherein:
at a starting point when the region with a relatively high resistance is gasified, there exists the liquid raw material between the region with a relatively high resistance and an outlet of the flow channel.

4. The method for spraying a liquid raw material for three-dimensional printing of claim 1, wherein:
the liquid raw material is a raw material in a molten state, or a raw material in a semi-molten state, or a solution, or a suspension liquid;
the gasification circuit is a part of the control circuit.

5. The method for spraying a liquid raw material for three-dimensional printing of claim 1, wherein:
major steps of spraying the liquid raw material consist in:
step S1, the control circuit controls the liquid raw material to flow inside the flow channel;
step S2, the liquid raw material forms a region with a relatively high resistance inside the flow channel; the region with a relatively high resistance of the liquid raw material is connected to the gasification circuit;
step S3, the current of a certain intensity is applied, and thus an effect of resistance heating is generated in the region with a relatively high resistance of the liquid raw material, so as to fully or partially gasify the liquid raw material in the region with a relatively high resistance;
step S4, an impact force generated through gasification pushes the liquid raw material between the region with a relatively high resistance of the liquid raw material and the outlet of the flow channel out of the flow channel.

6. A device for spraying a liquid raw material for three-dimensional printing, mainly consisting of a housing and a control circuit, wherein a raw material inlet and a raw material outlet are arranged on the housing, a flow channel is arranged inside the housing, the raw material inlet and the raw material outlet are connected with the internal flow channel, and the control circuit controls an operating process; wherein:
a narrow region is arranged inside the flow channel, an electrical access region is formed on each side of the narrow region, the electrical access region is utilized to guide a gasification current into the liquid raw material inside the flow channel; the current flows from the electrical access region on one side, through the narrow region, and then into the electrical access region on the other side; when the current flows through the narrow region, the liquid raw material in the narrow region is fully or partially heated and gasified, and an impact force generated through gasification pushes the liquid raw material inside the flow channel to be sprayed out of the raw material outlet;
the gasification current is utilized to heat and gasify the liquid raw material.

7. The device for spraying a liquid raw material for three-dimensional printing of claim 6, wherein:
the number of the flow channel is at least two, there exists an intersection between flow channels, and the narrow region is arranged at the intersection.

8. The device for spraying a liquid raw material for three-dimensional printing of claim 6, wherein:
the number of the flow channel is one, one end of the flow channel is connected with the raw material inlet, the other end of the flow channel is connected with the raw material outlet, and the narrow region is located between the raw material inlet and the raw material outlet.

9. The device for spraying a liquid raw material for three-dimensional printing of claim 6, wherein:
a solid raw material transportation unit and a heating unit are provided; the solid raw material transportation unit is utilized to feed the solid raw material into the flow channel; and the heating unit is utilized to heat the solid raw material, so as to generate the liquid raw material and maintain a molten state of the liquid raw material;
or, a heating unit is provided and no solid raw material transportation unit is provided; and the heating unit is utilized to maintain a molten state of the liquid raw material.

10. The device for spraying a liquid raw material for three-dimensional printing of claim 6, wherein:
an electrode is arranged at the raw material outlet.
